(19) United States
(12) Patent Application Publication
(10) Pub. No.: US 2009/0107003 A1
(43) Pub. Date: Apr. 30, 2009

(54) Technology for Cleaning Thermal Fatigue Cracks in Nickel-Based Superalloys With a High Chromium Content

(76) Inventors: Brigitte Heinecke, Mulheim an der Ruhr (DE); Michael Ott, Mulheim an der Ruhr (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/083,753

(22) PCT Filed: Oct. 6, 2006
(86) PCT No.: PCT/EP2006/067150

§ 371 Date: Apr. 18, 2008

(30) Foreign Application Priority Data
Oct. 26, 2005 (DE) 10 2005 051 310.7
Mar. 6, 2006 (EP) 06004538.2

(51) Int. Cl. F26B 3/00

(52) U.S. Cl. 34/493

(57) ABSTRACT

There is described a method for cleaning components that comprise cracks that are polluted with oxides, in particular gas turbine part. In said method, the components to be cleaned are exposed in a cleaning chamber at high temperature to a cleaning gas containing gaseous halogen compounds, which ionize to form halide ions. A cleaning gas is used containing 18 to 30% by volume hydrogen halide.

### CROSS REFERENCE TO RELATED APPLICATIONS

This application is the US National Stage of International Application No. PCT/EP2006/067150, filed Oct. 6, 2006 and claims the benefit thereof. The International Application claims the benefits of German application No. 10 2005 051 310.7 DE filed Oct. 26, 2005, and European Patent Office application No. 06004538.2 EP filed Mar. 6, 2006, all of the applications are incorporated by reference herein in their entirety.

### FIELD OF INVENTION

The present invention relates to a method for cleaning components, in particular gas turbine parts, having cracks contaminated with oxides in which the components to be cleaned are acted upon under the action of temperature in a cleaning chamber with a cleaning gas containing gaseous halogen compounds which dissociate to form halide ions.

### BACKGROUND OF INVENTION

Gas turbine components and, in particular, the turbine blades are exposed during operation, on account of the prevailing high temperatures and cyclic stresses, to pronounced loads which often result in the formation of thermal fatigue cracks. So that these cracks can be repaired by means of known soldering methods, oxide products first have to be eliminated which may be formed in the cracks under oxidizing conditions due to operation at high temperature. A cleaning method for removing such oxides from cracks is what is known as fluoride ion cleaning (FIC), such as is described, for example, in DE 28 10 598 C3. In this cleaning method, the component to be cleaned is exposed in a cleaning chamber, at a temperature of approximately 1000°, to a cleaning gas atmosphere containing gaseous fluorine compounds which, on account of the prevailing temperatures, dissociate to form fluoride ions which, in turn, are suitable for reducing the oxides present in the cracks. The known fluoride ion cleaning, however, is only inadequately capable of cleaning cracks in nickel-based superalloys (NBS) with a high chromium content of more than 10% by weight, since the oxides present, on the one hand, are closely packed and consequently present only a small attack area to the reaction gas and, on the other hand, have low volatility as metal fluorine compounds and therefore can be removed from the cleaning chamber only with difficulty.

### SUMMARY OF INVENTION

An object of the present invention, therefore is to specify a cleaning method of the type initially mentioned, by means of which cracks contaminated with oxides can be cleaned reliably.

This object is achieved, according to the invention, in that a cleaning gas is used which contains 18 to 30% by volume of a hydrogen halide, in particular in the form of hydrogen fluoride. It has been shown that cracks in components can be cleaned reliably if the cleaning gas contains a hydrogen halide in the specified range. This applies particularly to components consisting of chromium-containing alloys which have a chromium content of at least 10% by weight. This affords an optimal precondition for a complete wetting of the crack surface and for a filling of the crack with brazing metals.

According to one embodiment of the invention, there is provision for the cleaning gas to contain or consist of a mixture of the hydrogen halide and of a gas having a reducing action, in particular hydrogen. In this case, the gas having a reducing action assists the dissolving of the oxides contaminating the cracks and, consequently, the cleaning process. It became apparent that the method according to the invention is particularly effective when the cracks are acted upon with the cleaning gas at a temperature of 980° C. to 1100° C.

In an implementation of the invention, there is provision for the cleaning gas to be applied in a plurality of cleaning cycles which are interrupted by scavenging cycles, in the scavenging cycles the cracks being acted upon with a scavenging gas which is non-oxidizing and, in particular, has a reducing action, such as, for example, hydrogen, in order to remove from the cleaning chamber the metal halogen compounds which are formed. The scavenging operation may be assisted in that the cleaning chamber is pumped off during the scavenging cycles which preferably last for 2 to 10 minutes. Good results are achieved when three to ten scavenging cycles are carried out.

According to one embodiment of the invention, there is provision for each cleaning cycle to last for 10 to 60 minutes, the cleaning cycles preferably being of equal length. Moreover, after the last cleaning cycle, a scavenging cycle should take place, in order to ensure that the metal halogens formed are removed completely from the cleaning chamber.

After the cleaning treatment, the component can be annealed in a vacuum, annealing preferably taking place at the γ-solution annealing temperature of the material used for the component and preferably lasting for at least two hours. The annealing serves for cleaning reaction products from the component.

In a way known per se, the cleaning treatment according to the invention may be preceded by precleaning in a salt bath, preferably Durferrit RS DGS. Alternatively or additionally, precleaning in an acid bath or ultrasonic cleaning is also possible. The purpose of pretreatment is to dissolve easily accessible oxide coatings and thus to free the component surface, including the easily accessible crack start region, of oxides, before the lower-lying regions are cleaned by the cleaning gas in the cleaning chamber.

### BRIEF DESCRIPTION OF THE DRAWINGS

As regards further advantageous refinements of the invention, attention is drawn to the subclaims and to the following description of an exemplary embodiment, with reference to the accompanying drawing in which:

FIG. 1 shows diagrammatically the sequence of a method for cleaning components according to the present invention,

FIG. 2 shows diagrammatically the temperature and pressure profile during the fluoride cleaning segment of the cleaning method illustrated in FIG. 1,

FIG. 3 shows a list of superalloys,

FIG. 4 shows a gas turbine,

FIG. 5 shows a turbine blade, and

FIG. 6 shows a combustion chamber.

### DETAILED DESCRIPTION OF INVENTION

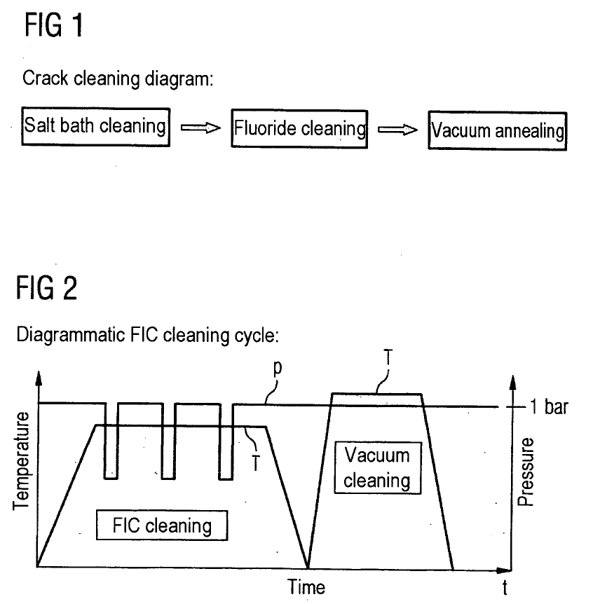

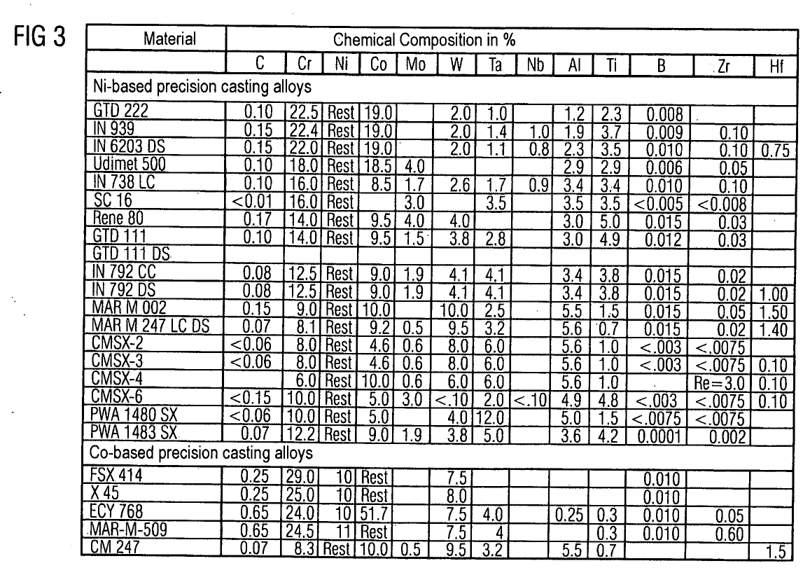

FIGS. 1 and 2 illustrate diagrammatically a method according to the invention for cleaning components which have cracks contaminated with oxides. The method is suitable particularly for cleaning moving blades and guide vanes 120, 130 of a gas turbine 100 and other components subjected to high stress during operation, such as, for example, the heat shield elements 150 of a combustion chamber 110 of the gas turbine 100. The method comprises the three segments of precleaning, fluoride ion cleaning and vacuum annealing. The precleaning, which is optional, but not absolutely necessary, and may consist, for example, of salt bath cleaning, serves for freeing the surface of the component 120, 130, 155 to be cleaned of superficial oxides and other corrosion products or for damaging these such that the subsequent fluoride ion cleaning can take place in an improved way.

After pretreatment, the component 120, 130, 155 is subjected to fluoride ion cleaning (FIC). During this FIC cleaning, which is already known per se, the component to be cleaned is exposed in a cleaning chamber to a cleaning gas atmosphere at temperatures in the region of 1000° C. The cleaning gas contains a hydrogen halide in the form of hydrogen fluoride (HF), which at the prevailing temperatures dissociates so as to form fluoride ions which, in turn, are suitable, by the formation of metal fluorides, for dissolving even complex oxides which have been formed in the cracks of the component.

In the method according to the invention, a cleaning gas is used which contains 18 to 30% by volume of hydrogen halide or hydrogen fluoride, the remaining gas being a non-oxidizing and non-corroding gas and, in particular, a gas, such as, for example, a hydrogen gas, which has a reducing action on oxides. The temperature in the cleaning chamber lies in a range of 980° C. to 1100° C. during the FIC cleaning.

Action of the cleaning gas in the form of the HF/H₂ mixture upon the component 120, 130, 155 to be cleaned takes place in a plurality of cleaning cycles which are interrupted by scavenging cycles with a scavenging gas which is non-oxidizing and, in particular, has a reducing action, such as, for example, hydrogen (H₂). The scavenging cycles may be assisted by the cleaning chamber being pumped off, in which case the cleaning gas in the cleaning chamber must be topped up before the next cleaning cycle. Cleaning by the cleaning gas being pumped off may likewise be interrupted. In the exemplary embodiment illustrated, four cleaning cycles are employed, which are interrupted by three scavenging cycles overall, scavenging likewise taking place at the end of the last cleaning cycle. However, the number of cleaning and scavenging cycles may also be markedly higher. Preferably, three to ten scavenging cycles are carried out.

The cleaning cycles in which the component is acted upon with the cleaning gas last in each case for 10 to 60 minutes and, in particular, 40 minutes, and the cleaning cycles may be of equal length. In the drawing, admittedly, the first and the fourth cleaning cycle are somewhat longer than the middle two cleaning cycles. The reason for this, however, is that, in the first cycle, the temperature first has to be increased in the desired range and, in the last cycle, the temperature has to be lowered again.

After the last scavenging cycle of the FIC cleaning, solution annealing treatment is carried out, in which reaction products, such as, for example, γ′-phases, such as occur in nickel-based superalloys, are dissolved.

FIG. 2 shows an illustrative temperature profile C and a pressure profile p in a graph against time t. A component 120, 130, 155 to be cleaned is introduced into the cleaning chamber, and the temperature T is raised to the desired range. In this case, the cleaning gas, here an HF/H₂ mixture, is introduced into the cleaning chamber. In this exemplary embodiment, four cleaning cycles take place, which are interpreted by three scavenging cycles. In these scavenging cycles, the gas mixture is also pumped off, so that the pressure within the chamber falls markedly during the scavenging cycles. In addition, a gas having a reducing action, such as, for example, hydrogen, is introduced into the chamber.

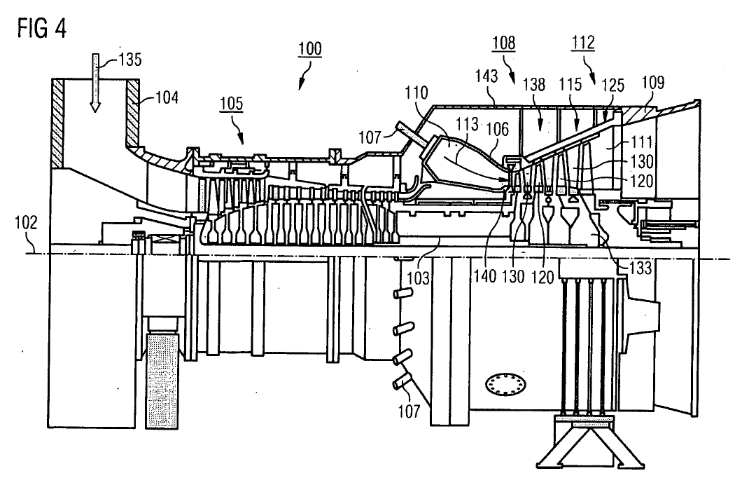

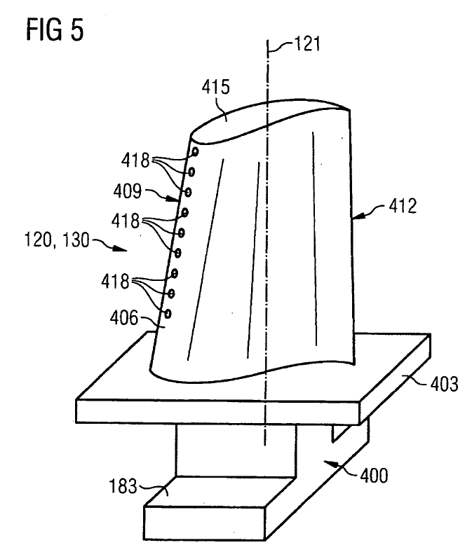

As already stated initially, the method according to the invention is suitable particularly for cleaning gas turbine components which consist of alloys with a chromium content of at least 10% by weight. Examples of such alloys are listed in Table 3. FIG. 4 shows by way of example such a gas turbine 100 in a partial longitudinal section.

The gas turbine 100 has inside it a rotor 103 rotary-mounted about an axis of rotation 102 and having a shaft 101, said rotor also being designated as a turbine rotor.

An intake casing 104, a compressor 105, a, for example, toroidal combustion chamber 110, in particular annular combustion chamber, with a plurality of coaxially arranged burners 107, a turbine 108 and the exhaust gas casing 109 follow one another along the rotor 103.

The annular combustion chamber 110 communicates with a, for example, annular hot gas duct 111. There, for example, four turbine stages 112 connected in series form the turbine 108.

Each turbine stage 112 is formed, for example, from two blade rings. As seen in the direction of flow of a working medium 113, a guide vane row 115 is followed in the hot gas duct 111 by a row 125 formed from moving blades 120.

The guide vanes 130 are in this case fastened to an inner casing 138 of a stator 143, whereas the moving blades 120 of a row 125 are attached to the rotor 103, for example, by means of a turbine disk 133. A generator or a working machine (not illustrated) is coupled to the rotor 103.

While the gas turbine 100 is in operation, air 135 is sucked in through the intake casing 104 by the compressor 105 and is compressed. The compressed air provided at the turbine-side end of the compressor 105 is led to the burners 107 and is mixed there with a fuel. The mixture is then burnt in the combustion chamber 110 so as to form the working medium 113. The working medium 113 flows from there along the hot gas duct 111 past the guide vanes 130 and the moving blades 120. At the moving blades 120, the working medium 113 expands so as to transmit a pulse, so that the moving blades 120 drive the rotor 103 and the latter drives the working machine coupled to it.

The components exposed to the hot working medium 113 are subject to thermal loads during the operation of the gas turbine 100. The guide vanes 130 and moving blades 120 of the first turbine stage 112, as seen in the direction of flow of the working medium 113, are subjected to the most thermal load in addition to the heat shield elements lining the annular combustion chamber 110.

In order to withstand the temperatures prevailing there, these may be cooled by means of a coolant. Substrates of the components may likewise have a directed structure, that is to say they are monocrystalline (SX structure) or have only longitudinally directed grains (DS structure).

For example, iron-, nickel- or cobalt-based superalloys are used as material for the components, in particular for the turbine blades 120, 130 and components of the combustion chamber 110. Such superalloys are known, for example, from EP 1 204 776 B1, EP 1 306 454, EP 1 319 729 A1, WO 99/67435 or WO 00/44949; these publications are part of the disclosure in terms of the chemical composition of the alloys.

The blades 120, 130 may likewise have coatings against corrosion (MCrAlX; M is at least one element of the group iron (Fe), cobalt (Co), nickel (Ni), X is an active element and stands for yttrium (Y) and/or silicon, scandium (Sc) and/or at least one rare earth element or hafnium). Such alloys are known from EP 0 486 489 B1, EP 0 786 017 B1, EP 0 412 397 B1 or EP 1 306 454 A1 which are to be part of this disclosure in terms of the chemical composition.

On the MCrAlX, a heat insulating layer may also be present and consists, for example, of ZrO₂, Y₂O₃-ZrO₂, that is to say it is not stabilized or is stabilized partially or completely by yttrium oxide and/or calcium oxide and/or magnesium oxide.

By means of suitable coating methods, such as, for example, electron beam evaporation (EB-PVD), columnar grains are generated in the heat insulating layer.

The guide vane 130 has a guide vane foot (not illustrated here) facing the inner casing 138 of the turbine 108 and a guide vane head lying opposite the guide vane foot.

The guide vane head faces the rotor 103 and is secured to a fastening ring 140 of the stator 143.

FIG. 5 shows a perspective view of a moving blade 120 or guide vane 130 of a turbomachine, which extends along a longitudinal axis 121.

The turbomachine may be a gas turbine of an aircraft or of a power station for electricity generation, a steam turbine or a compressor.

The blade 120, 130 has successively along the longitudinal axis 121 a fastening region 400, a blade platform 403 contiguous to the latter and a blade leaf 406.

As a guide vane 130, the blade 130 may have (not illustrated) a further platform at its blade tip 415.

In the fastening region 400, a blade foot 183 is formed which serves for fastening the moving blades 120, 130 to a shaft or a disk (not illustrated). The blade foot 183 is configured, for example, as a hammer head. Other configurations as a pine tree or dovetail foot are possible.

The blade 120, 130 has an inflow edge 409 and an outflow edge 412 for a medium which flows past the blade leaf 406.

In conventional blades 120, 130, for example, solid metallic materials, in particular superalloys, are used in all the regions 400, 403, 406 of the blade 120, 130.

Such superalloys are known, for example, from EP 1 204 776 B1, EP 1 306 454, EP 1 319 729 A1, WO 99/67435 or WO 00/44949; these publications are part of the disclosure in terms of the chemical composition of the alloy.

The blade 120, 130 may in this case be manufactured by means of a casting method, also by means of directional solidification, by a forging method, by a milling method or combinations of these.

Workpieces with a monocrystalline structure or structures are used as components for machines which are exposed during operation to high mechanical, thermal and/or chemical loads.

The manufacture of monocrystalline workpieces of this type is carried out, for example, by directional solidification from the melt. These are casting methods in which the liquid metallic alloy solidifies into the monocrystalline structure, that is to say to the monocrystalline workpiece, or directionally.

In this case, dendritic crystals are oriented along the heat flow and form either a column-crystalline grain structure (columnar, that is to say grains which run over the entire length of the workpiece and are designated here, according to general linguistic use, as being directionally solidified) or a monocrystalline structure, that is to say the entire workpiece consists of a single crystal. In these methods, the transition to globulitic (polycrystalline) solidification must be avoided, since, due to undirected growth, transverse and longitudinal grain boundaries are necessarily formed, which destroy the good properties of the directionally solidified or monocrystalline component.

When directionally solidified structures are referred to in general, this means both monocrystals which have no grain boundaries or, at most, low-angle grain boundaries, and columnar-crystal structures which, although having grain boundaries running in a longitudinal direction, have no transverse grain boundaries. These second-mentioned crystalline structures are also referred to as directionally solidified structures. Such methods are known from U.S. Pat. No. 6,024,792 and EP 0 892 090 A1; these publications are part of the disclosure.

The blades 120, 130 may likewise have coatings against corrosion or oxidation, for example (MCrAlX; M is at least one element of the group iron (Fe), cobalt (Co), nickel (Ni), X is an active element and stands for yttrium (Y) and/or silicon and/or at least one rare earth element or hafnium (Hf)). Such alloys are known from EP 0 486 489 B1, EP 0 786 017 B1, EP 0 412 397 B1 or EP 1 306 454 A1 which are to be part of this disclosure in terms of the chemical composition of the alloy.

On the MCrAlX, the heat insulating layer may also be present and consists, for example, of ZrO₂, Y₂O₃-ZrO₂, that is to say it is not stabilized or is partially or completely stabilized by yttrium oxide and/or calcium oxide and/or magnesium oxide.

By means of suitable coating methods, such as, for example, electron beam evaporation (EB-PVD), columnar grains are generated in the heat insulating layer, or, for example, atmospheric plasma spraying (APS), in which porous grains possessing microcracks and macrocracks are generated in the heat insulating layer.

Refurbishment means that components 120, 130, after being used, must, if appropriate, be freed of protective layers (for example, by sandblasting). After this, a removal of the corrosion and/or oxidation layers or products is carried out. If appropriate, cracks in the component 120, 130 are also repaired. Thereafter, a recoating of the component 120, 130 and a renewed use of the component 120, 130 take place.

The blade 120, 130 may be produced in hollow or in solid form. If the blade 120, 130 is to be cooled, it is hollow and, if appropriate, also has film cooling holes 418 (indicated by dashes).

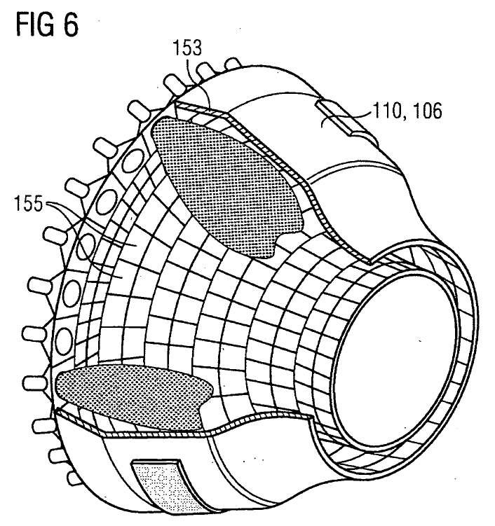

FIG. 6 shows a combustion chamber 110 of a gas turbine 100 (FIG. 4).

The combustion chamber 110 is configured, for example, as what is known as an annular combustion chamber, in which a multiplicity of burners 107 arranged around an axis of rotation 102 in the circumferential direction issue into a common combustion chamber space 154 and generate flames 156. For this purpose, the combustion chamber 110 is configured in its entirety as an annular structure which is positioned around the axis of rotation 102.

To achieve a comparatively high efficiency, the combustion chamber 110 is designed for a comparatively high temperature of the working medium M of about 1000° C. to 1600° C. In order to allow a comparatively long operating time even with these operating parameters which are unfavorable for the materials, the combustion chamber wall 153 is provided on its side facing the working medium M with an inner lining formed from heat shield elements 155.

Each heat shield element 155 consisting of an alloy is equipped on the working medium side with a particularly heat-resistant protective layer (MCrAlX layer and/or ceramic coating) or is manufactured from material resistant to high temperature (solid ceramic bricks).

These protective layers may be similar to the turbine blades, that is to say, for example, MCrAlX means: M is at least one element of the group iron (Fe), cobalt (Co), nickel (Ni), X is an active element and stands for yttrium (Y) and/or silicon and/or at least one rare earth element or hafnium (Hf). Such alloys are known from EP0 486 489 B1, EP0 786 017 B1, EP0 412 397 B1 or EP 1 306 454 A1 which are to be part of this disclosure in terms of the chemical composition of the alloy.

On the MCrAlX, a, for example, ceramic heat insulating layer may also be present and consists, for example, of ZrO₂, Y₂O₃-ZrO₂, that is to say it is not stabilized or is partially or completely stabilized by yttrium oxide and/or calcium oxide and/or magnesium oxide.

By means of suitable coating methods, such as, for example, electron beam evaporation (EB-PVD), columnar grains are generated in the heat insulating layer.

Refurbishment means that heat shield elements 155, after being used, must, if appropriate, be freed of protective layers (for example, by sandblasting). After this, a removal of the corrosion and/or oxidation layers or products is carried out. If appropriate, cracks in the heat shield element 155 are also repaired. Thereafter, a recoating of the heat shield elements 155 and a renewed use of the heat shield elements 155 take place.

On account of the high temperatures inside the combustion chamber 110, moreover, a cooling system may be provided for the heat shield elements 155 or for their holding elements. The heat shield elements 155 are then, for example, hollow and, if appropriate, also have film cooling holes (not illustrated) opening into the combustion chamber space 154.

1.-19. (canceled)

20. A method for cleaning a component, comprising:
providing a cleaning gas containing 18 to 30% by volume of a hydrogen halide;
providing the component having a crack contaminated with oxides, wherein the component to be cleaned is acted upon under action of temperature in a cleaning chamber with the cleaning gas containing gaseous halogen compounds which dissociate so as to form halide ions;
impinging the cracks with the cleaning gas at a temperature of 980° C. to 1100° C.;
applying the cleaning gas in a plurality of cleaning cycles which are interrupted by scavenging cycles;
impinging the cracks in the scavenging cycles with a non-oxidizing scavenging gas; and
performing each cleaning cycle for 10 to 60 minutes.

21. The method as claimed in claim 20, wherein the component to be cleaned is a part of a gas turbine.

22. The method as claimed in claim 20, wherein the hydrogen halide is present in the form of hydrogen fluoride.

23. The method as claimed in claim 20, wherein the cleaning gas contains a mixture of the hydrogen halide and of a gas having a reducing action.

24. The method as claimed in claim 23, wherein the gas having a reducing action is hydrogen.

25. The method as claimed in claim 20, wherein the cleaning gas consists of hydrogen halide and hydrogen.

26. The method as claimed in claim 20, wherein the cleaning and scavenging cycles directly follow one another.

27. The method as claimed in claim 20, wherein three to ten scavenging cycles are carried out.

28. The method as claimed in claim 26, wherein the cleaning cycles are of equal length.

29. The method as claimed in claim 26, wherein the scavenging cycles last for 2 to 10 minutes.

30. The method as claimed in claim 26, wherein the last cleaning cycle is followed by a scavenging cycle.

31. The method as claimed in claim 26, wherein the cleaning chamber is pumped off during the scavenging cycles.

32. The method as claimed in claim 26, wherein a gas having a reducing action is used as scavenging gas.

33. The method as claimed in claim 32, wherein the scavenging gas is a hydrogen gas.

34. The method as claimed in claim 20, further comprising annealing the component in a vacuum after the cleaning treatment.

35. The method as claimed in claim 34, wherein the annealing takes place at a γ′-solution annealing temperature of the material used for the component.

36. The method as claimed in claim 34, wherein the annealing at annealing temperature lasts for at least two hours.

37. The method as claimed in claim 20, wherein the cleaning treatment is preceded by a precleaning of the component in a salt bath.

38. The method as claimed in claim 20, wherein the component to be cleaned have chromium-containing alloys with a chromium content of at least 10% by weight.

39. The method as claimed in claim 38, wherein the component to be cleaned consists of directionally solidified casting alloys.
